(19) United States
(12) Patent Application Publication
(10) Pub. No.: US 2006/0259651 A1
(43) Pub. Date: Nov. 16, 2006

(54) Methods and apparatuses for providing combination personal computer cards

(75) Inventor: Ping Liu, South Surrey (CA)

Correspondence Address: THELEN REID & PRIEST, LLP, P. O. BOX 640640, SAN JOSE, CA, 95164-0640, US

(73) Assignee: SIERRA WIRELESS, INC.

(21) Appl. No.: 11/403,551

(22) Filed: Apr. 12, 2006

Related U.S. Application Data
(60) Provisional application No. 60/671,248, filed on Apr. 13, 2005.

(51) Int. Cl. G06F 3/00

(52) U.S. Cl. 710/8

(57) ABSTRACT

A method and apparatus for providing a combination PC card is disclosed. For one embodiment of the invention, a standardized platform is implemented on the card together with a common interface. The common interface allows any one of a number of different functional modules to be interconnected to the card providing an auxiliary functionality. Each functional module provides one or more specific functionalities. For one embodiment, the combination PC card implements one or more common interfaces each of which allows a functional module to be interconnected to the card.

### CROSS-REFERENCE TO RELATED APPLICATION

This application is a non-provisional application claiming priority to provisional application Ser. No. 60/671,248, filed on Apr. 13, 2005, entitled “Universal Combo Card Architecture,” which is herein incorporated by reference in its entirety.

### FIELD

Embodiments of the invention relate generally to the field of personal computing devices (PCs) and more specifically to PC add-on cards (PC cards) and methods and apparatuses to provide combination PC cards.

### BACKGROUND

PC cards such as PCMCIA 16-bit PC cards, CardBus cards, ExpressCard cards etc., are manufactured in a variety of sizes and used as expansion boards for PCs. Combination PC cards are available that combine multiple features in one PC card. For example, a manufacturer may provide multiple features built in one form factor. There are a number of features that may be combined in a combination PC card and a significant number of possible combinations for such features. For example, a user may desire a combination PC card that provides the features of both Bluetooth (a short-range networking protocol) and General Packet Radio Service (GPRS) (a GSM mobile data service).

Another user may desire a combination PC card providing the features of GPRS and WiFi (a wireless local area network (WLAN) compatibility specification). Still another user may desire a combination PC card providing the features of WiFi and Global Positioning System (GPS) (a satellite navigational system).

To meet these consumer needs, two or three different features may be implemented on a combination PC card. However, the various wireless service providers often prefer different combinations of the several features available. For example, a wireless service provider in Europe may require a combination PC card combining GPRS and Bluetooth, while a wireless service provider in the United States may require a combination PC card combining GPRS and WiFi.

The users may have differing needs as well. Some users may have laptop PCs that do not have WiFi built in, they may therefore desire a combination PC card that includes WiFi. Other users may have laptop PCs that have WiFi built in and therefore would have no need for a combination PC card that includes WiFi.

It is not feasible for a PC card manufacturer to include all of the features in a single combination card due to cost and manufacturing constraints. Moreover, it is cost prohibitive to manufacture a large number of different combination PC cards. Manufacturers have typically chosen to produce a limited number of different combination PC cards for markets with significant demand.

This presents the problems of reduced market diversity as manufacturers may not produce a combination PC card for a limited market. This also may lead to lost sales as users may not wish to purchase combination PC cards that incorporate unnecessary features. Also, limited selection means that users may pay higher prices where they do not require one or more of the combined features of a combination PC card.

Another difficulty facing combination PC card manufacturers is the result of the limited product lifetime of computer and communication components. For example, wireless technology is advancing so rapidly, that PC card products that had a typical product lifetime of 7-8 years a decade ago, now have a product lifetime of 2-3 years at most. Therefore, in order to address changing market conditions, PC card manufacturers have to redesign the combination PC cards more often, adding significantly to manufacturing costs.

### SUMMARY

In accordance with one embodiment of the invention Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a combination PC card in accordance with one embodiment of the invention;

FIG. 1A illustrates a combination PC card in accordance with one embodiment of the invention;

FIG. 2 illustrates a combination PC card and functional modules in accordance with one embodiment of the invention; and

FIG. 3 illustrates a process for producing a combination PC card in accordance with one embodiment of the invention.

### DETAILED DESCRIPTION

A method and apparatus for providing a combination PC card. For one embodiment of the invention, a standardized platform is implemented on the card together with a common interface. The common interface allows any one of a number of different functional modules to be interconnected to the card providing an auxiliary functionality. Each functional module provides one or more specific functionalities (e.g., GPRS, WiFi, GPS, etc). For one embodiment, the combination PC card implements one or more common interfaces each of which allows a functional module to be interconnected to the card.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

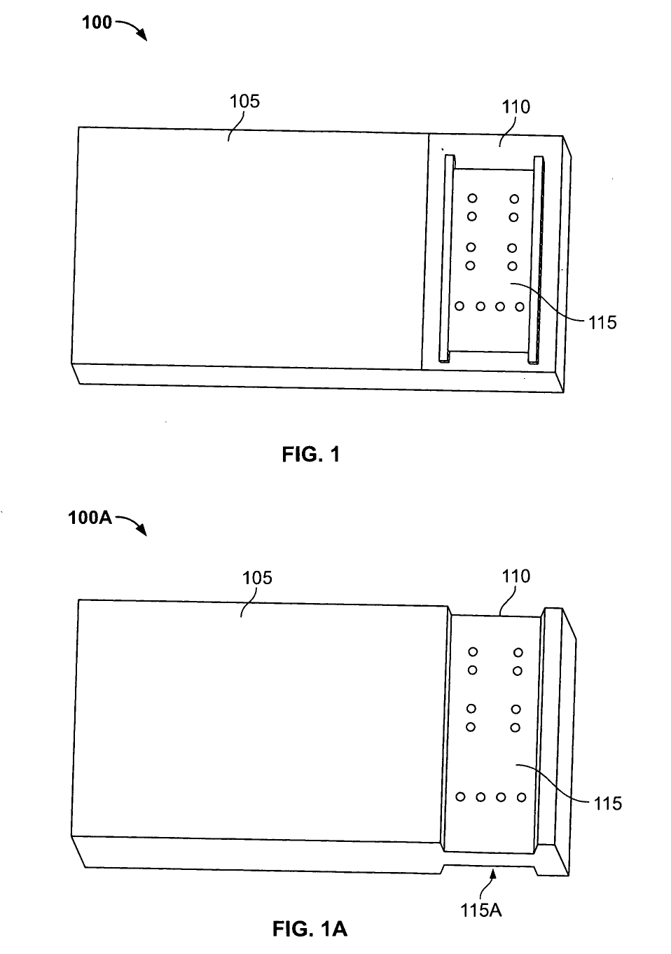

FIG. 1 illustrates a combination PC card in accordance with one embodiment of the invention. Combination PC card 100, shown in FIG. 1, includes a PC card slot portion 105, which is configured for insertion into a host slot of a device (e.g., a laptop PC). This portion may be a conventional PC card such as CardBus or ExpressCard. For one embodiment of the invention, the PC card slot portion 105 has a standard platform implemented thereon. For example, the standard platform may be a 3G (third generation mobile communications) technology such as Universal Mobile Telecommunications System (UMTS) functionality or, some other functionality.

Combination PC card 100 also includes a PC card extension portion 110. The extension portion 110 is configured to extend beyond the host slot of the device. The extension portion has implemented there on a common interface 115. The common interface 115 provides an electrical and mechanical interconnection for a functional module. Any number of functional modules may be designed for interconnection to the combination PC card 100 through common interface 115. For example, a functional module in accordance with an embodiment of the invention may implement one or more of the features of GPRS, Bluetooth, GPS and WiFi as well as other wireless communication functionality thus providing an auxiliary functionality to the combination PC card. For example, a functional module may implement an antenna (e.g., a patch antenna) for a wireless device. Additionally, a functional module in accordance with an embodiment of the invention may implement a thermal dissipation functionality. For example, a functional module may operate as a heat sink as described in U.S. patent application No. “TBD”, entitled “Methods and Apparatuses for Thermal Dissipation” filed on Apr. 13, 2006.

In accordance with one embodiment of the invention, a common interface may be implemented on an upper surface and a lower surface of an extension portion of a combination PC card. FIG. 1A illustrates a combination PC card in accordance with one embodiment of the invention. Combination PC card 100A, shown in FIG. 1A, includes a PC card slot portion 105, a PC card extension portion 110, and a common interface 115 as described above. Combination PC card 100A also includes a second common interface 115A implemented on an opposing surface of extension portion 110. For such an embodiment of the invention, two functional modules may be interconnected to the combination PC card concurrently. Such an embodiment, can therefore facilitate a functional module that is optimally positioned on an upper surface of the extension portion (e.g., a functional module implementing a patch antenna) as well as an additional functional module.

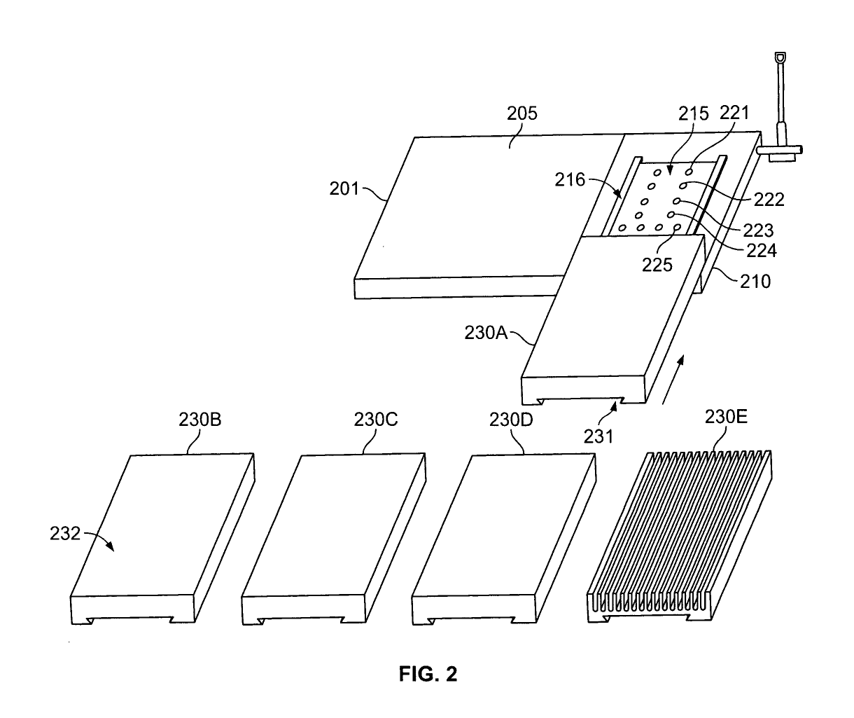

FIG. 2 illustrates a combination PC card and functional modules in accordance with one embodiment of the invention. PC card system 200, shown in FIG. 2, includes a combination PC card 201 having a PC card slot portion 205, a PC card extension portion 210, and a common interface 215. Common interface 215 includes a number of electrical interconnections shown, for example, as antenna connections 221, power and ground connections 222, Universal Serial Bus (USB) connections 223, Universal Asynchronous Receiver-Transmitter (UART) connections 224, and Module Identification connections 225. Module identification connections 225 provide an interface between a functional module and a module identification application resident on the combination PC card. The module identification application 225 identifies which of several functional modules is interconnected to the combination PC card.

Electrical interconnections 221-225 are exemplary. In general the common interface may contain any number of electrical interconnections including industry standard interconnections.

Combination PC card system 200 also includes a number of functional modules 230A-230E. As shown in FIG. 2, functional modules 230A implements WiFi functionality; functional modules 230B implements Bluetooth functionality; functional modules 230C implements GPS functionality; functional modules 230D implements a patch antenna functionality; and functional modules 230E implements a thermal dissipation functionality. Functional modules 230A-230E are exemplary. In general a functional module may implement any function appropriate for a PC card. For alternative embodiments of the invention, two or more functionalities may be implemented on a single functional module. Each of the functional modules is designed to interconnect, electrically and mechanically, to the common interface. The functional modules include interconnections corresponding to some or all of the interconnections (e.g., interconnections 221-225) on the common interface (e.g., common interface 215). Each of the functional modules interconnects to any of the interconnections of the common interface that are suitable to the specific functional module. Electrical interconnection between the common interface and the functional module may be maintained further through the use of spring loaded contacts 232 implemented within the functional modules.

Common interface 215 includes, in addition to electrical interfaces 221-225, a mechanical interface to interconnect the functional module to the combination PC card. For one embodiment of the invention, the common interface 215 includes a lip formation 216 that couples with a corresponding groove formation (e.g., groove 231) on the functional module to mechanically connect the functional module the combination PC card.

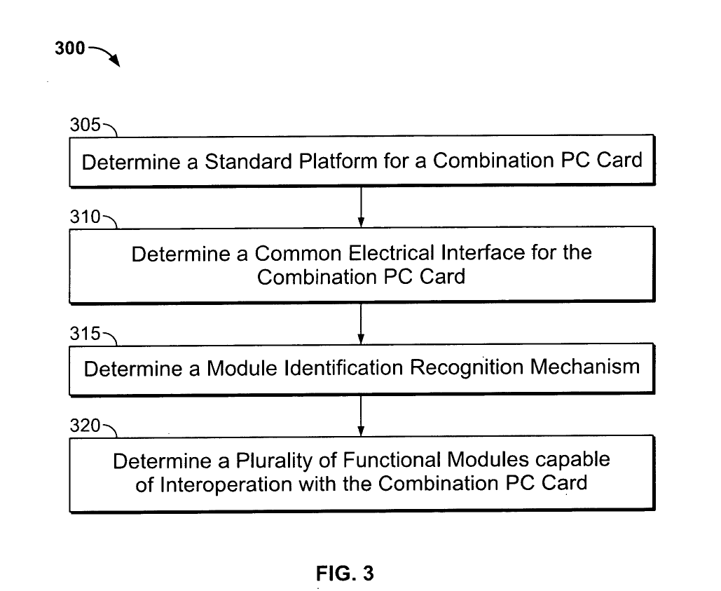

FIG. 3 illustrates a process for producing a combination PC card in accordance with one embodiment of the invention.

Process 300, shown in FIG. 3 begins with step 305 in which a standard platform for a combination PC card is determined. The standard platform may include a base form factor for a combination PC card. For one embodiment of the invention, the base form factor includes an extension portion for interconnecting a functional module. The standard platform also includes the base functionality of the combination PC card. For example the basic functionality may be UMTS. Alternatively, the basic functionality may be GPRS, EDGE, 1×RTT, or EVDO or other suitable functionality.

At operation 310 the common electrical interface is determined for the combination PC card. The common electrical interface may include USB, UART, I²C, power, ground, antenna, or other interconnections required for interfacing with a desired functional module.

At operation 315, a module identification recognition mechanism is determined and implemented. For example, a module identification application may be implemented on the combination PC card that allows the card to determine which of several functional modules is interconnected to the combination PC card. For one embodiment of the invention, the module identification application may be implemented in firmware of the combination PC card. When various functional modules are interconnected to the combination PC card, the applications do require modification or reconfiguration. The applications (e.g., software) for all supported modules are in the combination PC card. The module identification application determines which module is interconnected and thus which applications will be executed. For example, if the module identification application identifies a WiFi functional module, then a WiFi driver, resident on the combination PC card will be activated.

At operation 320 a plurality of functional modules capable of interoperation with the combination PC card are determined. For example, functional modules having interconnections corresponding to at least some of the interconnections of the common interface of the combination PC card. Functional modules may be designed to implement one or more of several functions as described above. Each functional module will include interconnections corresponding to some of the interconnections of the common interface based upon the functionality implemented on the module.

In various embodiments of the invention, common electrical and mechanical interface mechanisms may be implemented to ensure electrical and mechanical contact between the combination PC card and the functional module. For example, spring loaded contacts on either the common interface interconnections or the corresponding interconnections on the functional modules may be implemented as well as a common mechanical interface (e.g., clamping mechanism).

General Matters

Embodiments of the invention provide a combination PC card. For one embodiment of the invention, a standardized platform is implemented on the card together with a common interface. The common interface allows any one of a number of different functional modules to be interconnected to the card providing an auxiliary functionality. Each functional module provides one or more specific functionalities. For one embodiment, the combination PC card implements one or more common interfaces each of which allows a functional module to be interconnected to the card.

Embodiments of the invention have been described as including various operations. Many of the processes are described in their most basic form, but operations can be added to or deleted from any of the processes without departing from the scope of the invention. For example, FIG. 3 illustrates a process for producing a combination PC card in which a base form factor is designed having an extension portion for interconnecting a functional module to the combination PC card. In alternative embodiments, the combination PC card has a common interface implemented on the slot portion of the card. The functional modules interconnect to the slot portion of the PC card, which may not include an extension portion.

Some of the operations of the invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. Such embodiments of the invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A system comprising:
a personal computer card configured to implement a base functionality, the personal computer card having a common interface implemented thereon; and
a functional module coupled to the personal computer via the common interface, the functional module configured to interoperate with the personal computer card, the functional module selected from a plurality of functional modules, each functional module configured to implement one or more auxiliary functionalities.

2. The system of claim 1 wherein the base functionality is selected from the group consisting of GPRS, EDGE, 1×RTT, EVDO, UMTS.

3. The system of claim 1 wherein the common interface is implemented on an extension portion of the personal computer card.

4. The system of claim 1 wherein the common interface provides an electrical and mechanical interface.

5. The system of claim 1 wherein the one or more auxiliary functionalities are functionalities selected from the group consisting of Bluetooth functionality, GPRS functionality, WiFi functionality, GPS functionality, antenna functionality, thermal dissipation functionality, and combinations thereof.

6. The system of claim 1 wherein the common interface includes one or more standard electrical connections.

7. The system of claim 6 wherein the standard electrical connections include one or more connections selected from the group consisting of a USB connection, a UART connection, I2C connection, SPI connection, a power connection, a ground connection, and an antenna connection.

8. The system of claim 1 wherein the common interface includes a functional module identification connection configured to provide information from a functional module to a module identification application of the personal computer card.

9. A personal computer card comprising:
base functionality; and
a common interface configured to interconnect to one of a plurality of functional modules, each functional module configured to interoperate with the personal computer card and to implement one or more auxiliary functionalities.

10. The personal computer card of claim 9 wherein the base functionality is selected from the group consisting of GPRS, EDGE, 1×RTT, EVDO, and UMTS.

11. The personal computer card of claim 9 wherein the common interface is implemented on an extension portion of the personal computer card.

12. The personal computer card of claim 9 wherein the common interface provides an electrical and mechanical interface.

13. The personal computer card of claim 9 wherein the one or more auxiliary functionalities are functionalities selected from the group consisting of Bluetooth functionality, GPRS functionality, WiFi functionality, GPS functionality, antenna functionality, thermal dissipation functionality, and combinations thereof.

14. The personal computer card of claim 9 wherein the common interface includes one or more standard electrical connections.

15. The personal computer card of claim 14 wherein the standard electrical connections include one or more connections selected from the group consisting of a USB connection, a UART connection, I2C connection, SPI connection, a power connection, a ground connection, and an antenna connection.

16. The personal computer card of claim 9 wherein the common interface includes a functional module identification connection configured to provide information from a functional module to a module identification application of the personal computer card.

17. A method comprising:
determining a standard platform for a personal computer card, the standard platform specifying a set of physical dimensions of the personal card and a base functionality of the personal computer card; and
determining a common electrical interface for the personal computer card, the common electrical interface configure to allow a coupling of a functional module to the personal computer, the functional module configured to interoperate with the personal computer card, the functional module selected from a plurality of functional modules, each functional module configured to implement one or more auxiliary functionalities.

18. The method of claim 17 wherein the base functionality is selected from the group consisting of GPRS, EDGE, 1×RTT, EVDO, and UMTS.

19. The method of claim 17 wherein the common interface is implemented on an extension portion of the personal computer card.

20. The method of claim 17 wherein the common interface provides an electrical and mechanical interface.

21. The method of claim 17 wherein the one or more auxiliary functionalities are functionalities selected from the group consisting of Bluetooth functionality, GPRS functionality, WiFi functionality, GPS functionality, antenna functionality, thermal dissipation functionality, and combinations thereof.

22. The method of claim 17 wherein the common interface includes one or more standard electrical connections.

23. The method of claim 22 wherein the standard electrical connections include one or more connections selected from the group consisting of a USB connection, a UART connection, I2C connection, SPI connection, a power connection, a ground connection, and an antenna connection.

24. The method of claim 17 wherein the common interface includes a functional module identification connection configured to provide information from a functional module to a module identification application of the personal computer card.

25. A machine-readable medium that provides executable instructions, which when executed by a processor, cause the processor to perform a method, the method comprising:
recognizing a functional module coupled to a common interface of a personal computer card configured to implement a base functionality, the functional module configured to interoperate with the personal computer card, the functional module selected from a plurality of functional modules, each functional module configured to implement one or more auxiliary functionalities; and
activating an application associated with the recognized functional module.

26. The machine-readable memory of claim 25 wherein the base functionality is selected from the group consisting of GPRS, EDGE, 1×RTT, EVDO, and UMTS.

27. The machine-readable memory of claim 25 wherein the common interface is implemented on an extension portion of the personal computer card.

28. The machine-readable memory of claim 25 wherein the common interface provides an electrical and mechanical interface.

29. The machine-readable memory of claim 25 wherein the one or more auxiliary functionalities are functionalities selected from the group consisting of Bluetooth functionality, GPRS functionality, WiFi functionality, GPS functionality, antenna functionality, thermal dissipation functionality, and combinations thereof.

30. The machine-readable memory of claim 25 wherein the common interface includes one or more standard electrical connections.

31. The machine-readable memory of claim 30 wherein the standard electrical connections include one or more connections selected from the group consisting of a USB connection, a UART connection, I2C connection, SPI connection, a power connection, a ground connection, and an antenna connection.

32. The machine-readable memory of claim 25 wherein the common interface includes a functional module identification connection configured to provide information from a functional module to a module identification application of the personal computer card.
